(19) United States
(12) Patent Application Publication
(10) Pub. No.: US 2008/0181714 A1
(43) Pub. Date: Jul. 31, 2008

(54) Sponge device with urethane and cellulose material combination construction

(75) Inventors: Richard B. Fox, Smithfield, RI (US); James Gaudet, Blackstone, MA (US); Roger J. LaFlamme, Enfield, CT (US)

Correspondence Address: BARLOW, JOSEPHS & HOLMES, LTD., 101 DYER STREET, 5TH FLOOR, PROVIDENCE, RI, 02903, US

(73) Assignee: POLY-D, LLC, Torrington, CT (US)

(21) Appl. No.: 11/953,334

(22) Filed: Dec. 10, 2007

Related U.S. Application Data
(60) Provisional application No. 60/869,430, filed on Dec. 11, 2006.

(51) Int. Cl. A46B 11/02; B43K 5/00; B43K 5/02

(52) U.S. Cl. 401/188 R; 428/317.9; 401/205

(57) ABSTRACT

The sponge construction (100) includes two layers (102, 104) connected together. A layer of cellulose material (102) and a layer of urethane material (104) are connected to each other. For example, the layer of cellulose material (102) is laminated, bonded or adhered using an adhesive to the urethane material (104). The urethane material (104) is preferably reticulated foam. In an alternative embodiment, it is also possible that the sponge construction (200) integrally includes a dispensing device (202). For example, the dispensing device (202) is preferably a liquid pump (204) that pumps liquid (206) from a storage chamber (210) to location that is suitable for use, such as proximal to the layer of cellulose material (214) and/or the layer of urethane material (216) so that one of the layers (214, 216) can assist in distributing and applying the liquid (206) to be dispensed.

### CROSS REFERENCE TO RELATED APPLICATION

This application is related to and claims priority from earlier filed provisional patent application Ser. No. 60/869,430, filed Dec. 11, 2006.

### BACKGROUND OF THE INVENTION

This invention relates generally to devices, such as sponge constructions, for cleaning, scrubbing and dispensing applications. More specifically, the present invention relates to a new and unique device construction that is more well suited for scrubbing, absorbing and/or dispensing media than prior art constructions.

Various types of material and media are employed for different purposes throughout commerce and industry. Such media includes liquids, fluids, gels and even solids. For example, there are various products in the personal care, home care, air care, transportation care, and food industries that require some type of dispensing of a fluid material from a source of such material. When this material is sold in commerce, it must be contained and stored in some type of container. When that product is used, it must be dispensed from its storage container or chamber to a location for use where it can be applied, spread, as desired.

In the prior art, there are many different types of dispensers for delivering material, such as fluids and gels. For example, a flexible container body with a nozzle tip is commonly provided for such a purpose. An application of such use is for the dispensing of a liquid beverage where the container body is squeezed by the user to urge the fluid material out from the nozzle tip and accurately to a desired location, such as with the assistance of a straw. The amount of fluid is delivered by the user squeezing the container body an appropriate amount.

In another example of a prior art dispensing device, a flexible container holds a volume of fluid material to be delivered. A single one-way check valve is provided as an exit port from the flexible container. When the flexible body is squeezed, the material is urged out under pressure through the valve. Two valves may also be employed for further control of the flow of the media from the dispensing device for use by the user.

There is a need for a dispensing device to further include a applicator or other structure to assist in using the media once it has been dispensed. For example, a shoe polish dispenser typically includes an integrated sponge to help apply the polish that has been dispensed. Various constructions also include a sponge-like material about the dispenser or in a certain location to help spread and apply the dispensed media.

Whether or not these sponge-like constructions include an integrated dispenser for the media, they often include two opposing sides. Frequently, both sides are cellulose sponge material. This material is well suited for absorbing media and to help spread it. However, this material is not particularly abrasive for purposes of assisting in scrubbing. A scrubbing surface for a device is particularly helpful where the media is for cleaning purposes, such as dishwashing soap or bathtub cleaner.

In view of the foregoing, there is a need for a combination sponge construction that is easy to manufacture and can be both absorbent and abrasive for improved cleaning. There is a need for a construction that has shorter dry times than prior art constructions. There is a need for a composite sponge construction that has an alternative abrasive surface to the known non-woven surfaces of prior art devices.

### SUMMARY OF THE INVENTION

The present invention preserves the advantages of prior art dispensing devices and sponge constructions that are capable of dispensing various types of media, such as, liquids, gels and solids and/or applying such media with or without an integrated dispenser. The present invention provide a new and unique composite sponge construction. In addition, it provides new advantages not found in currently available constructions and overcomes many disadvantages of such currently available constructions. The present invention provides an alternative to known combination or composite constructions that include both cellulose and non-woven material in the same device.

The sponge construction includes two layers connected together. Preferably, a layer of cellulose material and a layer of urethane material are connected to each other. For example, the layer of cellulose material is laminated to the urethane material. The urethane material is preferably reticulated foam. In accordance with the present invention, it is also possible the sponge construction include a dispensing device integrated into the sponge construction. For example, the dispensing device is preferably a liquid pump that pumps liquid from a storage chamber to location that is suitable for use, such as proximal to the layer of cellulose material and/or the layer of urethane material so that one of the layer can assist in distributing the liquid to be dispensed.

### BRIEF DESCRIPTION OF THE DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a perspective view of a prior art two-layer sponge with a layer of cellulose material attached to a layer of woven fabric material;

FIG. 2 is a close up view of prior art reticulated foam;

FIG. 3 is a perspective view of a cellulose sponge;

FIG. 4 is a top view of the sponge construction of the present invention that includes a layer of cellulose material connected to a layer of reticulated foam;

FIG. 5 is a bottom view of the sponge construction of FIG. 4;

FIG. 6 is a cross-sectional view through the line 6-6 of FIG. 4;

FIG. 7 is a top view of an alternative embodiment of the sponge construction of the present invention that include a layer of cellulose material connected to a layer of reticulated foam with an integrated liquid dispensing device;

FIG. 8 is a bottom view of the sponge construction of FIG. 7; and

FIG. 9 is a cross-sectional view through the line 9-9 of FIG. 7.

### DETAILED DESCRIPTION OF THE PREFERRED EMBODIMENT

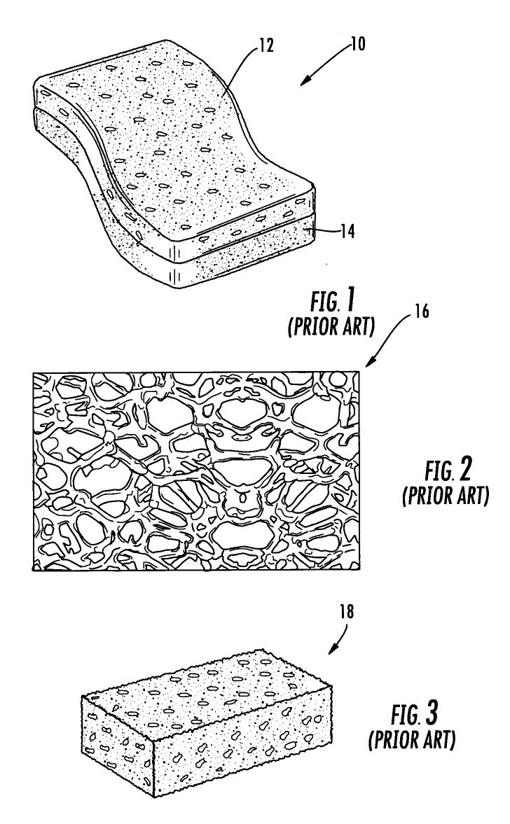

Turning first to FIG. 1 is perspective view of a prior art sponge construction 10 is shown. As is well known in the art, a layer of paper-based cellulose material 12 is attached to a layer of fabric or knitted material 14. This prior art construction 10 has the desired absorbent material 12 on one side and an abrasive material 14 on the opposing side thereof. As a result, the user has both capabilities of absorbency and abrasiveness in the same package 10. In use, for example, such a prior art sponge construction utilizes materials of cellulose material 12 bonded to a non-woven, knitted fabric material 14 for the scrub or cleaning side of the device 10. The cellulose 12 is used as the less aggressive cleaning surface side and the non-woven fabric or knitted side 14 is used as the aggressive cleaning side. The “Scotch Brite” 3M product is a good example of two different materials included in a single sponge construction. However, the known construction 10 of cellulose material 12 and non-woven material 14 suffers from various problems. For example, the non-woven material typically suffers from poor cleaning qualities and retains water making drying time undesirably long. As a result, the combination of materials in known sponge construction is inadequate to meet the needs of consumers.

Turning now to FIG. 2, a close-up image of reticulated foam 16 is shown which is well known in the art. Such a material 16 is expensive to manufacture, has good scrubbing characteristics and does not retain water like fabric, such as that used in the prior art of FIG. 1. FIG. 2 illustrates a prior art cellulose sponge 18 which is also inexpensive and has excellent absorbency characteristics. While these two materials are well known in the art to provide their respective advantageous characteristics, they have never been provided together in a single sponge construction.

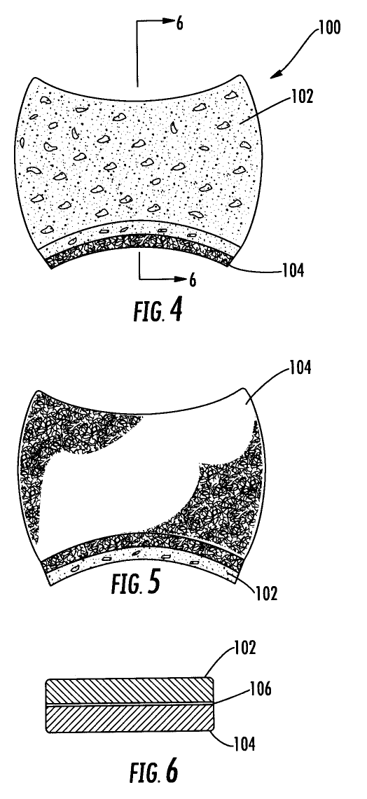

Turning now to FIGS. 4-6, the sponge construction 100 of the present invention is shown in detail. The sponge construction 100 incorporates both an absorbent material 102 with an abrasive material 104 for scrubbing without using known non-woven or knitted materials 14 of the prior art. More specifically, the sponge construction 100 of the present invention includes a cellulose material 102 attached to a urethane reticulated foam 104. This material is preferably a custom blended polyethylene.

The two materials 102, 104 are preferably attached or connected together by lamination, however, other methods, such as bonding and welding, can be used. Such as seen in FIG. 6, a layer of adhesive 106 can be used to secure the two layers 102, 104 together. The cellulose 102 offers the absorbent features required and the urethane 104 offers an alternative to the non-woven or knitted materials 14 found in prior art devices 10 and other known prior art constructions. The use of a urethane scrub layer of material 104 in the sponge construction 100 of the present invention improves the cleaning qualities over the prior art non-woven or knitted material 14 and the reticulated foam 104 will not retain water and is available at low cost. As a result, the construction 100 of the present invention dries out more quickly than prior art sponge constructions 10. Furthermore, the use of urethane 104 as the scrubbing surface provides a good air and water barrier. A strong joint with the cellulose material can be achieved unlike non-woven or knitted materials 14 of the prior art. This enables the design to be manipulated on a three dimensional basis which cannot be achieved in prior art constructions 10.

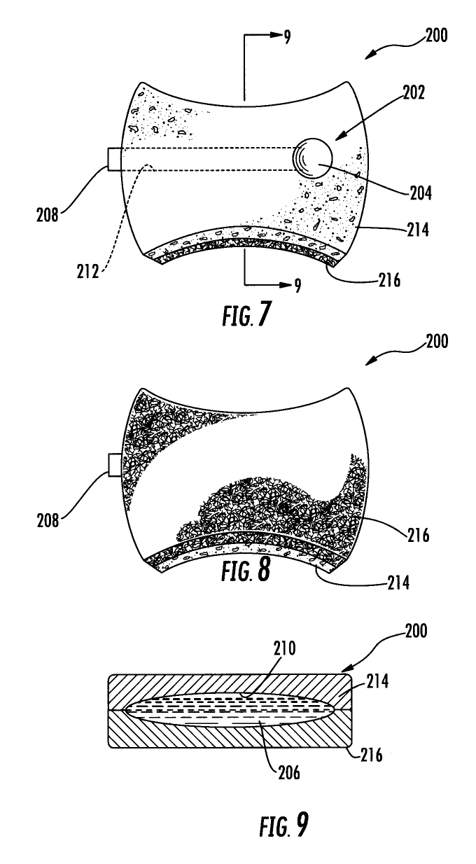

Turning now to FIGS. 7-9, a sponge construction 200 of an alternative embodiment of the present invention is shown. Cellulose layer 214 is connected to reticulated foam layer 216. This alternative construction 200 includes an integrated dispensing device, generally referred to as 202, that includes a flexible dome-shaped pump button 204, as in FIG. 7, to pull liquid 206, as in FIG. 9, and dispense it through output port 208. The dispensing device 202 can be any type of pump dispenser, including a dispensing pump that can meter a volume of liquid and then dispense it. The pump button 204 is depressed to draw liquid from storage chamber 210 to deliver it through exit conduit 212 to exit through exit port 208 for use and then optional subsequent application with the assistance of either or both of layers 214 and 216.

Further, the integrated dispenser 202 can be a single or multiple valve construction where the button 204 can be positioned anywhere on the device. Further, the exit port 208 can be a single outlet port or multiple ports positioned at any location on the device depending on the application at hand. The exit conduit 212 can also be positioned anywhere to suit the application at hand. The integrated dispenser 202 is optional but may be desired in certain sponge constructions made in accordance with the present invention.

It should be understood that the constructions of the present invention can be modified in many different ways to suit the application at hand. For example, various types of urethane can be used. Also, the cell size and hardness of the urethane can be customized to the end application of the device.

In view of the foregoing, a new and unique composite sponge construction is provided that is superior to known prior art constructions.

It would be appreciated by those skilled in the art that various changes and modifications can be made to the illustrated embodiments without departing from the spirit of the present invention. All such modifications and changes are intended to be covered by the appended claims.

What is claimed is:

1. A sponge construction, comprising:
a cellulose material; and
a urethane material connected to the cellulose material.

2. The sponge construction of claim 1, wherein the cellulose material is laminated to the urethane material.

3. The sponge construction of claim 1, wherein the urethane is urethane reticulated foam.

4. The sponge construction of claim 1, wherein the cellulose material is a layer of material and the urethane material is a layer of material.

5. The sponge construction of claim 1, further comprising:
a dispensing device integrated into the sponge construction.

6. The sponge construction of claim 5, wherein the dispensing device is a liquid pump.
